(19) United States
(12) Patent Application Publication
(10) Pub. No.: US 2009/0022256 A1
(43) Pub. Date: Jan. 22, 2009

(54) Method of generating electrical and heat energies via controlled and fail-safe fusion of deuterium in D2O bubbles cycled in radius from energies of ultra-sonic sound and amplitude modulated UHF EM in a narrow liquid D2O reaction gap between a pair of transducers and reactor therefore

(76) Inventor: Frank Boring Fitzgerald, Joliet, MT (US)

Correspondence Address: Frank Boring Fitzgerald, 6 Fitzgerald Lane Rockvale, Joliet, MT, 59041-9304, US

(21) Appl. No.: 11/880,031

(22) Filed: Jul. 20, 2007

(51) Int. Cl. G21B 1/11

(52) U.S. Cl. 376/113

(57) ABSTRACT

Disclosed is a method of Deuterium fusion and more particularly, a fail-safe, controlled bubble fusion reactor producing a power output of electricity and heat. It is self contained having 3 internal main chambers and externally mounted computer and electric power output terminals. Internal Chamber A contains devices for removing gases and solids, storage of fresh and spent liquid, pump and heat exchanger, pressure regulator and check valve, and sensors. Chamber B contains circulated pure liquid D₂O within which are mounted a pair of parallel electroacoustical piezoelectric quartz crystal transducers with a narrow reaction gap between supplied with transducer energies of ultra-sonic sound plus amplitude modulated UHF EM. A cycled gap sonic pressure wave creates small bubbles which absorb both gap energies so as to cycle through radius increases during the negative portion of the energies cycle and then violent collapse during the positive portion of the energies cycle to a very small radius in 2 stages. During end of final stage, a collapsing spherical bubble produces a spherical shock wave allowing “selective resonant tunneling” through the Coulomb barriers of pairs of adjacent Deuterium nuclei resulting in fusion. Chamber C contains 2 RF generators and some electronics for controlling the fusion reaction. External computer provides electronic fail-safe oversight, visual touch-screen display of system functions for monitoring and making adjustments, and manual by-pass fail-safe override push switch.

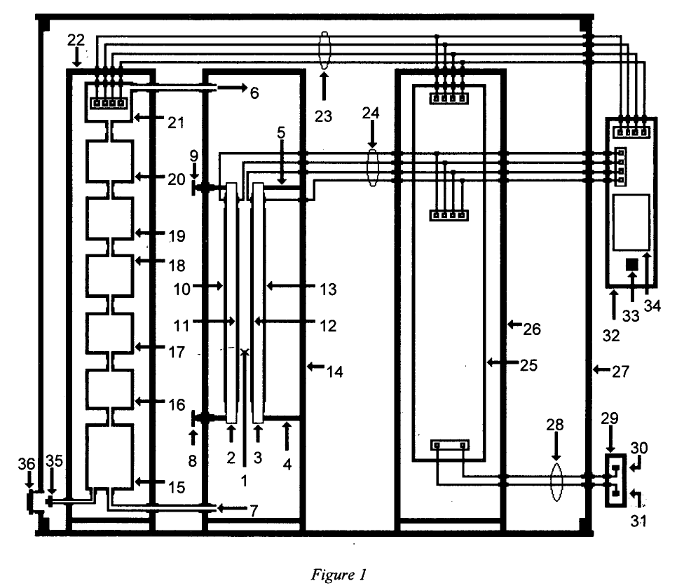

### INVENTION BACKGROUND ART

Hugh G. Flynn, U.S. Pat. No. 4,333,796, Jun. 8, 1982. His cavitation sonic bubble fusion patent disclosed a fusion reactor process as “warm fusion” at temperatures described as that of liquid soft metals not at “cold fusion” temperatures described herein as that of liquid D₂O. His patent covered 2 varieties of cavity fusion reactors each having 6 sonic generators. The reactor he described produced no electricity directly only heat but at high enough temperatures to sustain a steam turbine to generate electricity. His design did not suggest a fail-safe reactor nor was system functions monitoring included. Certain concepts of his sonic bubble fusion are in common with herein reactor with significant differences. His explanations were of immense value as guidelines to formulating concepts herein.

Robert A. Gross, U.S. Pat. No. 3,925,990, Dec. 16, 1975. His magnetic piston driven shock wave fusion patent disclosed a fusion reaction process as pulsed plasma “hot fusion” of shock wave confinement not at “cold fusion” temperatures described herein. His patent covered a pair of cylinders each with a magnetic piston. The reactor he described produced heat at a high enough temperature to drive a steam turbine to generate electricity. His design did not suggest a fail-safe reactor nor was system functions monitoring included. Certain conceptual aspects of his shock waves causing fusion are in common with herein reactor with significant differences.

Roger Stringham, First Gate Energies, PO Box 1230, Kilauea, Hi. 96754. Published literature, see www.lenr-canr.org/acrobat/StringhamRcavitationb.pdf, describe his bubble sonofusion process not entirely unlike as described herein. However, herein the fusion takes place within a very narrow liquid D₂O reaction gap between two parallel electroacoustical quartz crystal piezoelectric transducers each having an approximate 2 MHz thickness-vibration configuration which gap is also supplied with 300 MHz amplitude modulated UHF EM and which herein reactor generates a primary output power of electricity, secondarily of heat. The literature describing Stringham's design did not suggest a fail-safe reactor nor was system functions monitoring described. Certain concepts of his sonic bubble fusion are in common with herein reactor with significant differences.

Xing Zhong Li, Department of Physics, Tsinghua University, Beijing, 100084, China. Email Lxz-dmp@tsinghua.edu.cn First to formulate a “mathematical concept of selective resonant tunneling” as explanation for all known varieties of cold fusion including such sonic bubble fusion as described herein. His mathematical concepts cannot be applied directly herein to the fusion reaction without the necessary aids and events required as described herein, particularly the necessary focusing of spherical shock waves.

Rusi P. Taleyarkhan, et al, Purdue University Jul. 12, 2005 sonobubble fusion announcement. Taleyarkhan, et al and Forringer, et al, confirmed spherical bubble sonofusion designs by other scientists, such as Flynn, and, Stringham. Their confirmation allows the herein reactor and its design description some significant merit. Announcement of the Purdue experiments did not suggest a fail-safe reactor could be designed. His conduct during Purdue experiments is still a matter under investigation at last count. Discounting his conduct, his team did confirm spherical bubbles are required for fusion to take place. His report lead to development of this invention. This is dealt with further in this text below.

Edward Forringer, et al, of Le Tourneau University as reported in November 2006 Transactions of American Nuclear Society Vol. 95, P736. His group confirmed Taleyarkhan, et al, findings on their sonobubble fusion validity of prior experiments. Forringer's observations of experiments did not suggest a fail-safe reactor could be designed. His conduct during experiments is still a matter under investigation at last count.

T. Mizuno survived a lab explosion of such magnitude as to attribute it, in part, to fusion and lived to write about what to do and not do in lab experiments, see paragraphs [0020] and [0021] below, which other lab explosions have killed at least one experimenter. His inspiration has given this inventor direction to create fail-safe provisions decidedly built-in to the herein disclosed reactor so as to avoid Mizuno's and other lab problems of record. With fail-safe controlled fusion, this allows the herein disclosed reactor once built and operating to leave any lab while still safely delivering power to a load. The herein disclosed reactor does not need to only be operated under controlled lab conditions, but can be moved about for demonstrations, etc.

Website literature which also lead to this invention:

See www.newenergytimes.com/news/2005MTExplosion/explosion-net.htm

And, www.newenergytimes.com/news/2005MTExplosion/2005MizunoT-AccidentReport.pdf

See www.newenergy.com/Library/2000Li-Sub-BarrierFusion.pdf

Other references also supporting cold fusion technology specifically leading to this invention:

Note: While these below references do not directly apply as prior art to the herein described reactor and its design because the herein differs in overall processes from other types of cold fusion reactions mentioned, nevertheless, all prior art of the various types of successful cold fusion have lead to this invention and have in common Xing Zhong Li's mathematical model, which mathematics describe overcoming the Coulomb barrier existing between Deuterium positive ions via “selective resonant tunneling”, a concept derived by Li, et al, from quantum mechanics. The herein reactor and its described methodologies provide the necessary and proper aids and events as means leading to completion of “selective resonant tunneling” with D+D fusion as the result which overall herein described process has not heretofore been obvious to researchers and inventors as a proper course of justifiable intentional design outcome within previously known state of the art.

US Navy Research Laboratories at China Lake and San Diego, Calif., produced two reports which each contained on their last page: “Approved for public release; distribution is unlimited.” The reports confirm “cold fusion” of the electrolytic kind does exist contrary to so very many other published literature saying cold fusion of “any” type does not exist. Application of Li's “selective resonant tunneling” to the Navy's electrolytic process proves their process has the same D+D fusion reaction, via the tunneling thru Coulomb barriers of pairs of adjacent Deuterium nuclei resulting in fusion as this invention's sonic bubble fusion.

[A] Technical Report 1862, February 2002—Thermal and Nuclear Aspects of the Pd/D₂O System Vol 1: A Decade of Research at Navy Research Laboratories.

See www.spawar.navy.mil/sti/publications/pubs/tr/1862/tr1862-vol1.pdf

[B] Technical Report 1862, February 2002—Thermal and Nuclear Aspects of the Pd/D₂O System Vol 2: Simulation of the Electrochemical Cell (ICARUS) Calorimetry.

See www.spawar.navy.mil/sti/publications/pubs/tr/1862/tr1862-vol2.pdf

Issue 67, May/June 2006, Infinite Energy Magazine

See www.infinite-energy.com/iemagazine/issue67/apsmeeting.html

Jul. 12, 2005, researchers [Taleyarkhan, et al] at Purdue University announced they had new evidence supporting earlier findings by other scientists who had designed devices which used sound to produce sonofusion. Bubble fusion created in the Purdue sonic process were from perfectly spherical bubbles, and they collapsed with greater force than irregular shaped bubbles. Their research yielded evidence only spherical bubbles collapsing have enough energy to cause Deuterium atoms to fuse together. Their announcement appeared to this inventor to confirm Flynn's 1982 cavitation fusion USA patent explanation of failure of odd shaped bubbles to function in any sonofusion reaction whereas spherical bubbles would cause sonofusion.

Their announcement also appears to confirm Xing Zhong Li's mathematical model of selective resonant tunneling, which model when applied to sonofusion, appeared to this inventor to rely on proper focusing of shock waves generated in the bubbles via collapse of perfectly spherical bubbles as events necessary for cold fusion to work in this invention. Li's mathematical concepts, although not mentioned in the Purdue announcement, gives credence to utilization of the mathematical model in the herein reactor design now disclosed to be complete whereas prior art was incomplete absent Li's model as mathematical proof.

Further, the Purdue announcement showed this inventor, Li's mathematical model becomes ineffective in the presence of non-spherical bubbles hence no fusion reaction. This inventor put these details together in an inventive manner and concluded the way to fail-safe and reactor power output control was to combine all these disjointed details under effective electronic control.

### SUMMARY

The herein disclosed reactor and its described design methodologies utilize certain technologies which most by themselves each separately have been known in the prior art for some time but which when uniquely put together, with some additions and modifications, as in the herein disclosed particular reactor, such certain of the prior art technologies may now be safely utilized, overcoming inherent known problems of previous reactor designs, in a together manner which overall interactive disclosed details were not previously obvious to researchers and inventors versed in the art.

This disclosed reactor design allows generation of electrical and heat energies by fail-safe, controlled, fusion reaction of D+D resulting from high temperature and high pressure of an assisted focusing of a spherical shock wave on the inside of many tiny spherical bubbles, in the liquid D₂O reactor gap, at the depth of their collapsing cycle which cycle is produced by means of the bubbles absorbing and converting energies transmitted into the narrow liquid D₂O reaction gap between and from adjacent parallel electroacoustical quartz crystal transducer plates.

As a result of a bubble absorbing phased energies from the reaction gap this produces adiabatic non-linear changing of the bubble's radius, dielectric constant and density of bubble contents occurring in an accelerated positive feed mode.

High temperatures and high pressures begin to appear during the bubble final collapse portion of the cycle at about 60 nm bubble radius which started out at a maximum radius at or near about 1 μm, these figures according to some published literature.

These reaction gap energies consist of: ultra-sonic sound and amplitude modulated UHF EM carrier wave, which modulation is at the same frequency of the transducers, which AM is demodulated by the non-linear changing of bubble parameters, plus ultraviolet sonoluminescence produced in the bubbles at a critical point of the collapsing phase, which have then been re-absorbed, caused by the spherical shock wave.

Properly phased energy of the AM of the UHF EM carrier wave absorbs more into the bubble as the bubble's dielectric constant non-linearly increases with increasing temperature and pressure.

Also, via a reduction in propagation velocity of the UHF EM carrier wave with an increase in the bubble's dielectric constant, more energy of the AM of the UHF EM carrier wave is transferred to the bubble resulting in an increase of its violent collapse. The bubble absorption of these phased energies of sonic and demodulated AM of the UHF EM carrier leads to control over the creation, parameters, and utilization of the spherical shock wave. It is the shock wave itself which finally supplies the aids and events leading to D+D fusion and it is the phasing between sonic and AM of the UHF EM and as against the bubble cycle which causes the proper shock wave spherical shape. These aids and events are in the final analysis controlled via the reactor built-in electronics.

Combination of the 2 reaction gap wave energies properly phased relative to each other gives rise to adequate automatic electronic control of the eventual fusion reaction, via the built-in sensors, leading to a proper match of electrical output to load demand. Thus, firm control over the device and its fusion reaction.

The object of the earlier bubble cycle events is to produce the next step in the process that of formation of a spherical shock wave, tiny radius though it is, of enormous intensity which finally results in fusion reaction D+D. So, the fusion itself takes place at millions of degrees but it takes place in a liquid D₂O medium containing the minute bubbles.

The herein design relies upon Li's “selective resonant tunneling” through the Coulomb barriers between Deuterium positive ion nuclei in the final phase of bubble collapse to achieve fusion but in a progression of events of a significant difference from the other known types of cold fusion processes.

Reaction gap spacing is adjusted, between 20 and 50 μm, for maximum transfer of reaction energy to motion of the transducers during initial testing after construction of components and partial assembly.

### BRIEF DESCRIPTION OF REACTOR AND DESIGN METHODOLOGIES,

A fail-safe electronically controlled bubble fusion Deuterium reactor and its design methodologies are disclosed. In the drawing of the reactor, page 23 at [0107], the reaction Chamber B contains pure D₂O within which liquid are precision positioned two parallel electroacoustical quartz crystal transducers of piezoelectric thickness vibration configuration. The gap between them is very small and finely adjusted, between 20 and 50 μm, for maximum transducer electrical power output relative to production of heat.

Piezoelectric transducers herein are bilateral energy converters. They convert electrical energies into ultrasonic sound and UHF EM transmitted into the liquid D₂O reaction gap, and, by the action of D+D fusion mechanical motion bumping into the receiving transducers this results in piezoelectrical energy. Both depend on factors controlling the events of transmit-receive conversions as described herein.

Energies supplied to the D₂O reaction gap between the two transducers create in the reaction gap tiny cavitation bubbles which each forms around natural ions in the liquid which bubbles grow to maximum radius during the sonic negative pressure portion of the sonic cycle and then collapse violently during the positive portion of the sonic cycle in two stages phase locked in unison with cycles of the reaction gap energies.

This bubble expansion and contraction takes place adiabatic which provides the non-linearity required to allow bubble absorption of the amplitude modulation energy of the UHF EM carrier wave which AM is at the same frequency as the sonic wave. Thus, the bubble is exposed to two principle energies, sonic, and AM of the UHF EM, both at the same frequency. The bubble shape on collapse can be controlled via relative phasing of the two energies against each other and to the bubble cycle.

In the first stage of collapse, the bubble contents remain nearly at the temperature of the reaction gap liquid D₂O but in the second stage the increasing speed of collapse during the positive portion of the sonic cycle, causing an adiabatic increased compression of the bubble contents, first produces total ionization in the bubble and then ionization in the thin shell of D₂O surrounding the bubble. As a result of changes in cycling phase of the ultra-sound and AM of the UHF EM reaction gap energies, application of an increasing phased pressure on the bubble accelerates this violent adiabatic collapsing stage, substantially increasing the dielectric constant and density of the bubble in a positive feedback mode assisting absorption of the AM of the UHF EM, and causes the bubble to contract to a much smaller radius more violently, thus increasing temperatures and pressures reached within the bubble. Published estimates in the literature indicate the maximum temperature reaches 10¹⁰ K and the maximum pressure reaches 10⁹ atmospheres both together are sufficient to cause D+D fusion via Li's “selective resonant tunneling” through the Coulomb barrier.

At a certain radius of the collapsing bubble [about 1 μm or less according to the literature] sonoluminescence takes place which generation has a tendency to delay the rate of collapse but does not stop the collapse. As the bubble nears its minimum radius, about 60 nm by some published estimates, the bubble, if it is still spherical at the decreasing radius, generates, internally, an intense spherically focused shock wave, [instead of sonoluminescence] creating the aforementioned high pressures and high temperatures in the shock wave as it approaches the minute bubble surface. Dielectric constant and density in the shock wave itself is very high which differs radically from those before and after the shock wave producing a positive feedback mode of spherically focused shock wave transmission aiding in further increasing rate of absorption energies of sonic and AM of the UHF EM. Small as the bubble is, the shock wave, tiny as it is, is properly focused at the bubble surface as a result of the bubble itself being perfectly spherical at these portions of the bubble collapse cycle. Disclosed herein is how the sphericalness of the bubble is maintained so as to accomplish two things: 1) nullifying effects of gravity, motion, orientation, and stray magnetic fields; and, 2) control of fusion reaction to properly match load demand.

These extremely high temperatures and high pressures occur both within the surface of the bubbles and due to the shock wave, in immediate layers of the reaction gap D₂O. At initial reactor startup, the thermonuclear reaction is generated, via “selective resonant tunneling”, mainly by collision of bubble surface Ds in the shock wave with very large cross section target Ds naturally confined, via the metal surface work function and plasmon quanta, at the surface plates of the transducers across the reaction gap and thereafter the reaction takes place primarily on the inside of the surface of the bubbles themselves at the focus of the shock wave in the shock wave itself via “selective resonant tunneling”. All this is as a result of the reaction gap ultra-sonic sound energy together with aiding energy of AM of the UHF EM, and ultraviolet sonoluminescence re-absorption and a proper generation of and focusing of the spherical shock wave.

This allows D+D nuclei Coulomb barrier “selective resonant tunneling” to take place during initial setting up of the fusion reaction in the shock wave whether it is at the surface of the opposing transducer plates, or inside the surface of the bubble. Fusion reactions then generate heat together with bubble positive ion Oxygen moderated impact mechanical motion of the transducers which motion generates electrical energy as the reactor's primary output. Secondarily, the heat is removed from the reactor container walls.

Coulomb barrier “selective resonant tunneling” model allows D+D fusion herein to take place well below energies required in the Tokamak and in general class Stars by a factor of at least three. The reaction gap UHF EM is RF energy which couples from the transducer plates across the reaction gap and exists as a EM wave in the D₂O because the reaction gap D₂O is pure free of those contaminates which would otherwise, if present, absorb the UHF EM. This is reason enough to use only pure D₂O. Bubbles must absorb the AM of the UHF EM energy not any contaminates.

The relative phasing between the ultra-sonic sound and the AM of the UHF EM overwhelms effects upon the bubble shape due to earth's gravity which gravity destabilizing effects were enunciated in Flynn's USA patent. Because Flynn's device was large, about 1 m cubed, he found he had to incorporate an adjustable magnetic field in order to stabilize the bubble shape as it was collapsing. Because the herein reactor has a narrow reaction gap, in the elms, between the transducers, this herein design can use the relative phasing between bubble absorption of reaction gap energies to accomplish the necessary shape stability without a magnetic field. Electronic sensors built-in to the herein reactor device can sense and effect corrections caused by Earth's gravity, motion, device orientation, and stray magnetic fields which may exist in the reaction gap and which if un-corrected could cause serious results.

The gas separator has certain adaptations which allow the reactor to be insensitive to reactor orientation or motion. The reactor has on board certain sensors to control the fusion reaction so it can be operated at any position, vertical or horizontal, and may be moved about. The sensors allow the reactor to operate in stray magnetic environments of transformers, solenoids, power lines or magnets.

This is accomplished by sensors monitoring the load demand versus load voltage which then electronically automatically adjusts the phase positioning of both these reaction gap energies in relationship to the bubble phase of collapse thereby controlling shape of the bubbles. The phasing of ultra-sonic sound and AM of the UHF EM are thus the controlling factors of bubble shape and stability of the fusion reaction. The overall electronic safe-guards prevent any chance of a run-away reactor.

The narrow reaction gap width is finely adjusted, between 20 and 50 μm, during testing after construction and partial assembly to allow maximum transfer of fusion energy to the transducers generating piezoelectric RF output from the crystals into Chamber C where it is converted into DC or 60 Hz for output to an external load.

That fusion reaction control is a simple process for electronics and at the same time the electronic monitoring is accomplished, should something go wrong, a backup senses there is a problem and provides a fail-safe electrical short circuit upon each of the transducer crystals and at the same time shuts down the UHF EM generator. Hence at shut down there are no spherical bubbles. This can be accomplished within a cycle of the crystals' vibration. The battery in the external computer supplies the electrical power needed in Chamber C at startup and recharges after the device is up and running.

The above disclosed reactor configuration can be “stacked into a variety of physical and power outputs—not limited to the herein single given device. The number of transducers in Chamber B is not limited to only two per reactor device, provided components of Chamber A and C and the programs in the computer are changed to match the needs of Chamber B.

### DETAILED DESCRIPTION OF REACTOR AND DESIGN METHODOLOGIES

A portion of the disclosure of this patent document contains material which is subject to copyright protection. This inventor, copyright owner, has no objection to the facsimile reproduction by anyone of the patent document or the patent disclosure, as it appears in the Patent and Trademark Office patent file or records, but otherwise reserves all copyright rights whatsoever.

In The Drawing of the reactor: page 23 at [0107] is an overall schematic drawing of the disclosed bubble fusion reactor. The drawing of the reactor page 23 at [0107] is not to scale overall nor to scale of any component. It is about 20 cm on each side. The gas separator [15] has certain adaptations so it can be operated mobile, at any orientation angle, at any altitude, and in outer space. It is called a cold fusion reactor because bubble fusion takes place in the narrow “liquid” D₂O reaction gap [1] between a D of a collapsing bubble surface and a D confined by the surface work function in quantum plasmon pores of the transducer's [2] [3] chrome surfaces [11] [12], as well as between adjacent Ds inside the bubble at its surface, focus of the collapsing bubble shock wave, with its high temperature and high pressure both sufficient to allow D+D fusion to take place, but no other. The reactor is housed in a lead lined stainless steel container [27] to prevent any possible radiation from escaping.

Chamber A [22] contains pressurized storage for fresh 100% pure D₂O [20], storage for spent fluid [19], pressure regulator and check valve [18], circulation pump and heat exchanger [17], solids filtration [16], separator of gases [15], and various sensor devices [21]. The circulating pump in [17] circulates the D₂O thru Chamber B [14] at a rate of about 1 liter per month, using the heat exchanger [17] as the source of pump [17] power.

Chamber B [14] contains 2 electroacoustical piezoelectric quartz crystal transducers: 1.) each side of transducer [2] is plated with electrodes [10] [11]; and, 2.) each side of transducer [3] is plated with electrodes [12] [13]. The transducers [2] [3] are separated by a very narrow liquid D₂O reaction gap [1], which D₂O reaction gap is adjusted [8] [9], between 20 and 50 μm, for maximum ratio of reactor electric power output [30] [31] to heat production obtained from reactor case [27] during testing following construction of components and partial assembly.

This disclosed design will be confined herein to quartz crystal transducers [2] [3] because the technology of quartz crystals is the most popular, well-know, readily available, cost effective, and more easily adapted to mass production, testing, adjusting [8] [9], and quality control of such reactor design as incorporated herein. Nevertheless, other electroacoustical transducer materials will also work. However, all such other materials must withstand the highly corrosive action of pure D₂O. Gold and chrome were chosen [over silver and palladium] for their resistance to corrosion of pure D₂O. Corrosion contaminated lab D₂O in the past has been an unsuspected event leading to much criticism therein calling electrolytic cold fusion fraud because it did not work whereas the failure of most such lab cold fusion experiments could be attributed to un-pure D₂O. Contamination is expected and accounted for in this invention via incorporating a filter of solids [16], a separator of gases [15], storage for spent D₂O [19], and storage for fresh D₂O [20].

In Chamber C [26], electronics in [25] contain several components. An RF Generator [25] at the transducer [2] [3] resonant frequency which starts the transducers [2] [3] in the transmitter mode producing reactor gap sonic energy leading to the D+D fusion process and then shuts down after unit is working in the receiver mode at which point terminals [30] [31] on terminal block [29] supply electric power output from the transducers [2] [3]. Electronics of [25] also contains a UHF RF generator, an AM modulator at the transducer frequency, which comes on line at initiating of startup controlled via the external computer [32], which generator output adds appropriately phased AM of the UHF EM energy coupled from transducer plates [11] [12] into the D₂O reaction gap [1] between the transducers [2] [3] to assist mainly in controlling bubble shape.

External computer [32] contains a battery and some electronics, an externally accessible button positive-detent-push-switch [33] is provided for panic manual by-pass of electronics for over-ride shut-down, and, a touch-screen LCD [34] provides for visual monitoring, adjustments, startup, and maintenance shut-down of the over-all system. Its battery is used to power up Chamber C electronics at startup which thereafter is kept charged via electric power supplied from Chamber C.

This device uses, in part, among other things, concepts created, enunciated, or modeled by: Flynn; Stringham; Taleyarkhan, et al; Forringer, et al; Gross; Xing Zhong Li, and Butt; which certain of these concepts deal with cold fusion\bubble fusion\cavitation bubble fusion. Those prior art D+D fusion processes, as were described by them, were generated only via ultrasonic sound and not together with the moderator AM of the UHF EM energy as both are incorporated herein. Xing Zhong Li's historical contribution was to explain in mathematical terms why and how all six forms of cold fusion work, via his mathematical “selective resonant tunneling model” overcoming the D+D nuclei Coulomb barrier at a lower temperature and lower pressure then required by general class Stars and by Tokamaks.

The quartz crystal transducers [2] [3] operating in the thickness vibration mode, not the cantilever mode as explained below at paragraphs [0074] and [0075], are plated [0] [11] [12] [13] on both sides of each crystal, with an identical very thin layer of gold upon which each are identically flashed two very thin layers of chrome, one on top of the other. The chrome plating bath is electrically polarized so the second flash is accomplished polarized at right angles to the first. The chrome plates [10] [11] [12] [13] then have cross-lattice quantum plasmon pores on their crystal type surface sufficient to hold Deuterium ions via a strong work function at its surface. Much like an ion sticking its head out of a quantum well.

The initial and continuous Deuterium ion loading of the chrome plates [11] [12], at opposite sides of the D₂O reaction gap [1], occurs as a result of natural D ions occurring in liquid D₂O [1]. The Brownian movement aided by gap energies circulates the D ions onto the chrome plates [11] and [12] with the metal surface work function with its quantum plasmon pores holding onto the Ds trapping them there increasing target cross section of the Ds enhancing the “selective resonant tunneling” needed for initial reactor startup. The transducers [2] [3] in Chamber [B] [14] are submerged in liquid D₂O continuously fed from entrance [6] through D₂O reaction gap [1] and exiting [7] under pressure suitable to formation of bubbles in the D₂O reaction gap [1] caused by the energies between the two transducers [2] [3]. Anchors [4] [5] of crystal [3] prevent circulation of liquid D₂O on that side of [3] while adjusters [8] [9] prevent circulation of liquid D₂O on that side of crystal [2]. Thus the only circulating liquid D₂O takes place through the D₂O reaction gap [1].

The two transducer crystals [2] [3] are placed into thickness resonance via applying to their plates [10] [11] [12] [13] on opposite sides of each crystal [2] [3] an RF energy kept at their mechanical resonant frequency via electronics [26] in Chamber C [26], which under this RF power, the crystals [2] [3] increase and decrease physical thickness at their resonant frequency, generating high intensity ultrasonic energy in the liquid D₂O reaction gap [1] between the two transducers [2] [3].

The vibrating thickness mode was selected over the vibrating cantilever mode to provide: (1) a better transducer transmission match of each crystal's [2] [3] internal impedance to the work load impedance of the liquid D₂O reaction gap [1] as the D₂O changes to scattered sonic bubbles; and, (2) by a better match to the transducers [2] [3] when acting as receivers from fusion energies at the plates [11] [12] during the different phase angle of crystal [2] [3] vibration, in addition to crystal [2] [3] energies mode via fusion products bombarding the crystal plates [11] [12] from the bubbles in the liquid D₂O reaction gap moderated by the Oxygen ions. The matching of impedances is not an obvious prior art applicable to this design and device except to suggest looking at sonar technology but in a setting of fusion products (condition 2 of this paragraph) bombarding the crystals instead of sonar reflections.

This transducer [2] [3] transmitted sonic vibration energy coupling to the D₂O reaction gap [1] causes highly localized D₂O vapor bubbles which are formed in a positive feedback mode of changes in the dielectric constant as the D₂O goes from a liquid to a gas bubble then to ionized Deuterium gas [and ionized Oxygen gas] within which bubbles, when adiabatic collapsing, produce an extremely intense shock wave with its high wave surface temperature and extremely high pressure, sufficient to bombard the stationary Deuterium held on the surface of the chromed plates [11] [12] which Deuterium thereon has a large target cross-section due to surface effects confinement.

The ionized Oxygen is expected to serve as a buffer assisting and moderating fusion products bombardment of the plates [11] [12] because it is not at a sufficiently high enough temperature and pressure to become part of the overall nuclear reaction. Thus, it acts as a catalysis assisting transfer of energy from the fusion reaction to impact caused thickness changes of the transducers [2] [3]. The resonant mechanical thickness changes of the transducer crystals [2] [3] causes piezoelectric generation of RF voltage at the crystal [2] [3] resonant frequency between their plates [10] [11] [12] [13] of the transducers [2] [3] which RF energy is fed into Chamber C [26] electronics [25] via cable [24] and on into external computer [32] with electrical power output taken via cable [28] to terminals [30] and [31] on external block [29].

The result is Deuterium fusion D+D which takes place in the minute bubbles occurring in pulses at an overall rate equal to the crystal RF. The crystal RF generator in [25] of Chamber C [26] starts the crystal plate [11] [12] surface fusion reaction idling process in Chamber B [14]. The crystal RF generator in [25] is then shut down because the varying piezoelectric effect, synchronized with pulsating fusion reaction are all in positive feedback mode which generates RF which causes the ultrasonics which causes the bubbles which causes pulsating fusion within the bubbles themselves [1] and on the chrome electrodes [11] [12] with piezoelectrically generated energy taken off as reactor electrical power output from Chamber C [26] between external terminals [30] [31] on terminal block [29]. And, heat is exchanged from heat exchanger [17] to surface of Chamber A [22] and also from Chamber B [14] both wind-up at the reactor container walls [27] from which heat is extracted as energy output. So, there are two forms of energy produced, that of electrical energy, and, that of heat energy.

The D₂O reaction gap liquid [1] in Chamber B [14] is continuously exchanged from out of [6] through [1] into [7] with fresh D₂O [20] from chamber A [22] via therein a circulating pump [17], pressure regulator [18], filter of solids [6], check valve [18], and separator of gases [15]. So, D+D fusion during reactor startup begins at the surface of the porous chrome plates [11] [12] then switches mostly to inside surface of the bubbles adjacent to the plates [11] [12]. Corrosion of the plates [11] [12] is reduced via the buffer action of the non-fusion Oxygen after reactor startup. Thus, the reactor would be on line full time and not shut down until maintenance is required.

The narrow D₂O reaction gap [1] between crystal transducers [2] [3] allows therein the relative phasing between gap energies to predominate and overwhelm: motion and orientation of reactor; Earth's gravity; and, stray magnetic fields. It is not necessary to supply a gravity overwhelming magnetic field to compensate for Earth's gravity as was required in the Flynn U.S. Pat. No. 4,333,796 cavitation process. The Browning movement drives fusionable D ion mates from the D₂O reaction gap to be held at the surface of the chrome plates [11] [12] confining Ds there as if in quantum wells and holding those D's ready as a target with large cross section.

This allows bubble shock wave utilization of energies in the D₂O reaction gap [1]. These energies are then given the opportunity, sufficient time, 10 to 50 picoseconds by some estimates in the literature, to add their energies to “selective resonant tunneling” leading to fusion at temperatures far below that of Tokamaks or general class Stars.

In Flynn's 1982 U.S. Pat. No. 4,333,796 patent he pointed out an unstable bubble shape was due to Earth's gravity [tiny as it is] which resulted in a bubble not being able to produce high enough temperatures and pressures during final collapse phase for fusion to take place due to non-spherical bubble shape [lack of fusion caused by what we now know to be an upsetting of “selective resonant tunneling” due to shock wave misfocusing]. Flynn made it clear the bubble must be spherical during final phase of collapse or else fusion does not take place and the reactor shuts down. Those Flynn assumptions were in general, confirmed in the July 2005 Purdue University findings, and reaffirmed in the November 2006 Tourneau University findings. Those successful assumptions are utilized in the herein disclosed design of the reactor.

The controlling electronics [25] in Chamber C [26], controls relative phasing of the D₂O reaction gap [1] energies of ultra sound and UHF EM, allowing various physical orientations of the reactor to suit installation requirements such as a moving vehicle or vessel, aircraft, and hand held devices.

[23] [24] [28] are inter-connecting cables with insulation and feed-throughs are pretested to withstand temperatures of 200° C., pressures of 10 atmospheres, water proof rated, and tested to carry 10 Amps at 600 Volts. All sensors, electrical and electronic circuits, and internal computer chips are designed and tested to withstand 1.5 Mev radiation at 200° C., and pressures of 10 atmospheres.

Reactor memory problem overcome in this design:

The bubble fusion reactor just described, were it to be absent any built-in contrary electronic control [25], would have a “self-destructive memory”, that is, once started, it would be self running at its maximum rate of reaction, load or no load, and not merely operate at idle, eventually to self-destruction and possible explosion. Nuclear reactors of any kind can not be operated without having a completely adequate fail-safe system in place ready to be activated upon command of built-in automatic safe-guards with manual override of paramount importance. Such “memory”, per se, is not in the literature but would become obvious to those in the art once such a device disclosed herein [without electronic controls built-in] were put into their hands absent any references to the “memory” problem. That is largely the reason some labs have had explosions. So how is it controllable? How is it shut down? How safe can a fail-safe system be?

The answer to the “memory” problem is built-in contrary memory electronic control [18] [21] [25] [32] as in the herein disclosed reactor with manual override [33]. This electronic [18] [21] [25] [32] override control is accomplished by phasing of the D₂O reaction gap [1] energies relative to each other and to the bubble cycle thus changing the shape of the bubbles from spherical to something less than perfectly spherical; the herein reactor then can not produce fusion. The manual override [33] provides a short circuit of each crystal transducer preventing the transducers from being able to produce reaction gap energies. Flynn in his U.S. Pat. No. 4,333,796 1982 patent said of his reactor non-spherical bubbles produce no fusion. This spherical versus non-spherical was confirmed in 2005 by the Purdue University group and verified by the Le Tourneau University group in 2006.

Bubbles all entirely spherical produce a maximum fusion reaction. Bubbles of a sufficiently non-spherical shape result in no fusion. Control of the fusion reaction is one being a control of the precise shape of the bubbles which can be rather fast changeable, in theory. This is accomplished in the herein design [18] [21] [25] [32] by electronically controlling intensity, frequency, and phase angle relationships of the ultra-sonic sound, and UHF EM RF energies as between each other and the phase angle of bubble collapse in the D₂O reaction gap [1] between the crystal plates [11] [12]. This would have the effect of distorting the shape of bubbles and changing other factors. The memory control circuitry [18] [21] [25] [32] is the same circuitry used for nullifying the effects of gravity, motion, orientation, and stray magnetic fields.

This disclosed herein fusion reactor memory control [18] [21] [25] [32] and thereby the nullifying effects of motion, orientation, gravity, and stray magnetic fields are caused to immediately take place via changing, “de-tuning”, the resonant frequency of the crystals [2] [3] while at the same time to change the intensity, frequency, and phase angle of UHF EM pulses from [25] with overall D₂O reaction gap [1] energy parameters a function of memory control [18] [21] [25] [32] with each energy at a relative phase angle to the other and to the collapsing bubbles. These two main reaction gap energies, ultra-sonic sound, and UHF EM, which cause the bubbles in the first place now are able to modify shape of the bubbles keeping the reactor under firm control to match any load. This is where electronic monitoring and electronic control plays a part [18] [21] [25] [32] with signals carried via cables [23] [24]. In order to produce a controllable electric power output [30] [31] via cable [28] commensurate with any and all load conditions, at any physical orientation, the fusion reaction process must match the load via suitable electronic sensors [21] and controls [18] [21] [25] [32] built into the reactor design.

In the herein design, the exact frequency of the RF energy supplied to the crystals [2] [3], and, the exact frequency of the UHF EM pulses [25] supplied via cable [24] to the bubbles in the D₂O reaction gap [1] from crystal plates [11] [12], both are automatically adjusted [18] [21] [25] [32] frequency-wise, phase-wise, and amplitude-wise relative to each other so bubble shapes are firmly appropriate to reactor load, physical motion, gravity, orientation, stray magnetic field, and memory nullification.

With no load, reactor activity is kept at idle [18] [21] [25] [32] supplying only the bare necessary energy to keep the reactor alive. The electronic controls [18] [21] [25] [32] are then on idle waiting to bring the reactor up to any load demand. As load demand changes, the electronic controls [18] [21] [25] [32] adjusts the crystals' [2] [3] RF energy input\output parameters via automatically adjusting to another proper frequency thru a corrective mechanical change via “electronically de-tuning” of the crystals [2] [3] plus adjusting the UHF EM pulses phase angle positioning to match the crystals' [2] [3] de-tuning. This has the effect of changing bubble shape and changing other factors. This aspect of reactor operation, if separated from the herein design, is not obvious art because the herein design has not been made public. Once public, all aspects together in the herein design should be obvious to those trained in the art and the design should gain wide acceptance in the scientific community through lab replication.

“Fail-safe” equals electronically sensing a wrong operating condition and automatically adding an electrical short circuit, generated in [25] and controlled in external computer [32], between plates of both crystal [2] plates [10] [11], and crystal [3] plates [12] [13], at the same time disconnecting the crystal RF generator in [25], and, the UHF EM pulses generated in [25], both otherwise supplied to the bubbles, which both techniques by-pass the fine “tuning” procedures needed for matching the bubble fusion reaction to the load. But if something does go wrong, this fail-safe is done electronically, automatically, and if need be, manually via actuating the shunt switch [33] on computer [32].

Run-away fusion reactions can take place very quickly, as described in the literature, see paragraphs [0020] and [0021], so, vital built-in precautions are essential when any experiment or device is ready to run.

1. A method of producing ultra-sonic bubble Deuterium-Deuterium nuclear fusion in a narrow liquid reaction gap of pure D₂O between a pair of parallel electroacoustical piezoelectric quartz crystal transducers therein which during transmission mode applies an acoustical pulsing field, modified and assisted by UHF EM amplitude modulated at the frequency of the transducers, to the reaction gap which fields create alternating negative and positive pressure pulses in the liquid D₂O to vary its ambient pressure sufficiently to induce in the liquid in said reaction gap a cavitation effect which causes small bubbles in the liquid to expand by means of the negative pressure pulse and then to collapse violently by means of the positive pressure pulse producing a high temperature high pressure shock wave thereby overcoming the Coulomb barrier of Deuterium nuclei via selective resonant tunneling; with built-in electronics which automatically overwhelms and counterbalances effects of reactor motion, orientation, gravity, stray magnetic fields, and natural attempts at reactor run-away; in a self-contained reactor container utilizing specific devices for filtering gases, solids, storage of spent and fresh liquid D₂O, pressure regulation and check valve, heat exchanger and pump, sensors, and electronic signals generation with automatic fail-safe control circuits both internally and in the external computer, which has visual monitoring and manual programming and adjustment provisions with manual over-ride switch, thereby overall creating fail-safe methods for producing, containing, controlling, and auto-adjusting the bubble fusion reactions; resulting in electrical and heat power output.

2. A method as defined in claim 1 wherein the effects of reactor motion, orientation, gravity, stray magnetic fields, and natural attempts at reactor run-away are overwhelmed and counterbalanced in said liquid D₂O reactor gap by creating an electronically generated proper phase relationship between the ultra-sonic sound and the UHF EM amplitude modulated frequency of the transducers with proper phase relationships to said bubbles during their expansion and collapsing phases thereof in said liquid D₂O reactor gap.

3. A method as defined in claim 1 wherein to generate, control, and supply ultrasonic sound energy and AM UHF EM energy to said liquid D₂O reaction gap.

4. A method as defined in claim 1 wherein to maintain to a proper ambient temperature, pressure, and circulation of fresh liquid D₂O for spent liquid D₂O in said liquid D₂O reactor gap.

5. A method as defined in claim 1 wherein primary power output electrical energy piezoelectrically generated in said transducers as a result of the bubble fusion impacts on the transducers is transferred to external terminals to which an electrical load is attached.

6. A method as defined in claim 1 wherein secondary power output heat energy generated in said transducers and in said liquid D₂O reactor gap as a result of the bubble fusion is transferred to the outside environment via warmth of the reactor container itself having been mainly supplied with heat from said heat exchanger.

7. A method as defined in claim 1 wherein said piezoelectric generated electrical energy from said transducers is utilized to control fusion reaction via “electronic detuning” techniques of said transducers and adjustments of phase relationships between said reaction gap energies and to the phase of the bubble cycle so as to match fusion reaction to electrical power output load.

8. A method as defined in claim 1 wherein said sensors sensing problems feed signals to said external computer which automatically results in reactor fail-safe shut down via electrically short circuiting both transducers.

9. A method as defined in claim 1 whereby said external computer panel provides for visually monitoring, adjusting, and setting controls via a touch-screen Liquid Crystal Display, all functions of the system in a fail-safe manner; and, for manually, via an over-ride push-switch, to by-pass electronics and short circuit both crystal transducers which kills the reactor.
